(19) United States
(12) Patent Application Publication
(10) Pub. No.: US 2002/0080738 A1
(43) Pub. Date: Jun. 27, 2002

(54) Hard handoff method for packet mobile network

(76) Inventors: Kyung-Sik Kim, Taejon (KR); Sang-Ho Choi, Taejon (KR); Dong-Jin Shin, Taejon (KR)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/846,464

(22) Filed: Apr. 30, 2001

(30) Foreign Application Priority Data
Dec. 22, 2000 (KR) 2000-80922

(51) Int. Cl. H04Q 7/00

(52) U.S. Cl. 370/331

(57) ABSTRACT

A high speed handoff in a packet mobile communication network is disclosed. A packet radio communication network for providing a packet data service such as the internet in the IMT-2000 is being developed in many countries of the world. In this context, a network constitution, functions for respective constituents and a service providing procedure are disclosed for PN-4286. In the PN-4286, however, the conventionally proposed packet handoff procedure is based on the assumption of a simple data service. Therefore, a high speed handoff cannot be supported unlike in the line network, due to the re-setting of the link levels, the user certification and the IP registration of the packet terminal. This makes the real time service difficult in the packet network, and therefore, the use of the mobile packet network is limited to the simple data service. The present invention solves these problems by proposing a new handoff procedure. Further, various matters for carrying out this procedure are presented, so that a high speed handoff can be supported in the mobile packet network.

### TECHNICAL FIELD

The present invention relates to a method for providing a high speed handoff in a packet mobile communication network. More specifically, the present invention relates to a hard handoff method in a packet mobile communication network, in which a high quality real time service can be provided.

### BACKGROUND OF THE INVENTION

At present, the IMT-2000 proposes a packet data service, and the handoff procedure of PN-4286 is illustrated in FIG. 1.

First, data are exchanged between a mobile client (MC) and a packet data serving node (PDSN**) through a PPP session, and if a handoff is requested, the currently serving radio network (RN*) sends a handoff request to the target radio network (RNt) (S2).

Under this circumstance, a packet parameter including a session ID is sent, and this is for speedily realizing the handoff to the RNt. When the handoff procedure proceeds in the normal manner, and thus, when a hard handoff or a partial soft handoff is carried out, a radio resource controller (RRC) such as a concerned base station or a base control station has to be necessarily changed.

Then the RNt decides as to whether a handoff has to be carried out, so as to respond to the RN* (hard handoff response) (S3). Then the radio network (RN*) notifies the handoff to the RNt to the mobile client (MC) (hard handoff directive (S4). Then a traffic channel is formed between the mobile client and the RNt (transfer of traffic channel) (S5).

Then in order to set a packet service to a target packet data service node (PDNSt), the RNt transmits a set-up message, and at the same time, a session ID is sent to the PDSNt. Through this session ID, the PDNSt recognizes a new R-P (start packet service [session-ID]) (S6).

Then upon completion of the handoff, the RN* notifies to the PDSN** the fact that the channel to the mobile client has been closed, and records a tentative billing to the AAA server (close packet end point) (S7). Then the PDSNt sets a PPP session to the MC (establish PPP) (S8). Under this condition, a PPP certification for a mobile IP is not carried out.

Then in order to carry out a mobile IP registration procedure after a PPP initialization, the PDSNt sends an agent advertisement to the MC, and the MC sends an agent solicitation to the PDSNt (mobile IP reg. req.) (S9). That is, the MC forms a mobile IP registration request.

Then by utilizing an AAA protocol, the PDSNt loads the registration request on an AMR (AA-mobile-node-request) to send it to the AAA server (SI 1). Then the AAA server replies to the AMA (AA-mobile-node-answer) message (S 12). The PDSNt confirms the mobile IP registration response, and notifies this to the MC (mobile IP reg. reply) (S13). In this manner, the data service is activated between the PDSNt and the MC through the PPP session (user data) (S14).

Thus during the time when the hard handoff procedure (S5-S13) is carried out between the MC and the packet data service node, the transmission data cannot be delivered to the user.

Under this condition, if the transmission data is not a real time data, the data which cannot be delivered during the handoff can be retransmitted after buffering the data, but it is not an easy matter to decide the size and position of the buffer. Particularly, in the case of a real time data, the buffering transmission is not feasible.

### SUMMARY OF THE INVENTION

The present invention is intended to overcome the above-described disadvantages of the conventional technique.

Therefore it is an object of the present invention to provide a hard handoff method in a packet mobile communication network, in which in order to solve the problems occurring during the handoff in the third generation packet mobile communication network, multiple PPP sessions are set and control functions are carried out for the mobile clients, thereby providing a high speed handoff method.

In achieving the above object, the handoff method for making an MC continuously receive an internet service by carrying out a hard handoff according to the present invention includes the steps of:

carrying out a handoff procedure with a target radio network upon encountering a hard handoff situation in a mobile client (first step);

carrying out a mobile IP registration procedure for the mobile client and for the target packet data service node of the target radio network (second step); and

shifting a traffic channel of the mobile client to a target packet data service node from a current packet data service node (third step).

### BRIEF DESCRIPTION OF THE DRAWINGS

The aforementioned aspects and other features of the present invention will be explained in the following description, taken in conjunction with the accompanying drawings, wherein:

FIG. 1 is a flow chart showing the handoff method which has been proposed at PN-4286;

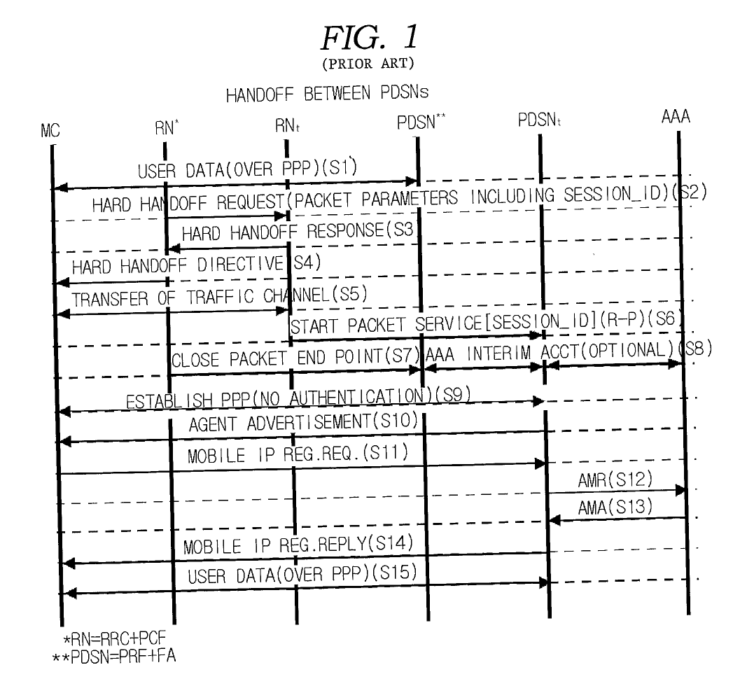

FIG. 2 is a flow chart showing the handoff method according to the present invention; and

FIG. 3 is a transition view showing the terminal status for carrying out the procedure according to the present invention.

### DETAILED DESCRIPTION OF THE INVENTION

The hard handoff method in the packet mobile communication network according to the present invention will be described referring to the attached drawings.

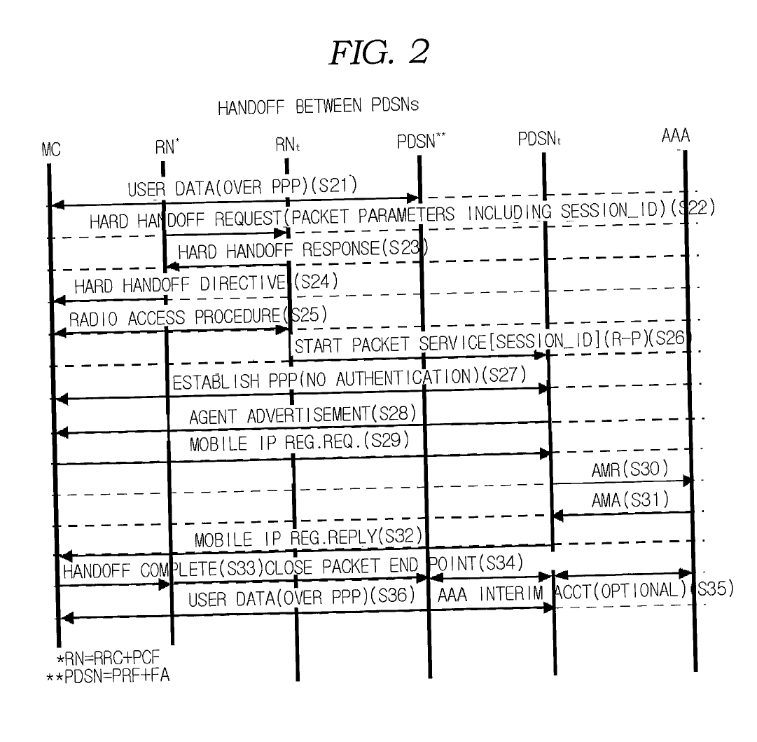

FIG. 2 is a flow chart showing the handoff method according to the present invention.

First, data are exchanged between a mobile client (MC) and a packet data service node (PDSN**) (S21), and then, if a handoff is requested, the currently serving radio network (RD*) sends a handoff request to a target radio network (RNt) (S22). Under this condition, a packet parameter including a session ID is sent, and this is for making the handoff to the RNt speedily realized. When the handoff is request, an RRC has to be necessarily changed.

The RNt decides as to whether the handoff is to be carried out or not, and sends a reply to the RN* (S23). The RN* notifies the handoff to over the RNt to the MC (S24), and the MC carries out a radio-connection-to-RNt-procedure (S25).

The RNt notifies this fact to the PDSNt so as to set up a packet service, and under this condition, a session ID is sent to the PDSNt. The PDSNt recognizes a new R-P through the session ID (S26). Then the PDSNt sets up a PPP session with the MC (S27). Under this condition, a PPP certification procedure for the mobile IP is not carried out.

In order to carry out a mobile IP registration procedure after a PPP initialization, the PDSNt sends an agent advertisement to the MC (S28), and the MC sends an agent solicitation to the PDSNt. Under this condition, the MC forms a mobile IP registration request (S29).

Then by utilizing an AAA protocol, the PDSNt loads a registration request on an AMR message to send it to the AAA server (S30). The AAA server replies to the AMA message (S31). Then the PDSNt confirms the mobile IP registration reply so as to notify the result to the MC (S32).

Upon completion of the handoff, the MC notifies the fact to the RN* (S33), and the RN* notifies the closure of the channel of the MC to the PDSN** (S34), and records a tentative billing to the AAA server (S35). In this manner, the data service is activated between the PDSNt and the MC through the PPP session (S36).

The above described handoff method has the following advantages. That is, the shifting of the traffic channel is realized after setting of all the links, and therefore, any breaking of the packet which has been the conventional problem can be avoided. Particularly, in the packet network, the audio and video can be served in the form of a real time service, and therefore, users can efficiently utilize the resources by connecting to such a packet network at a low cost.

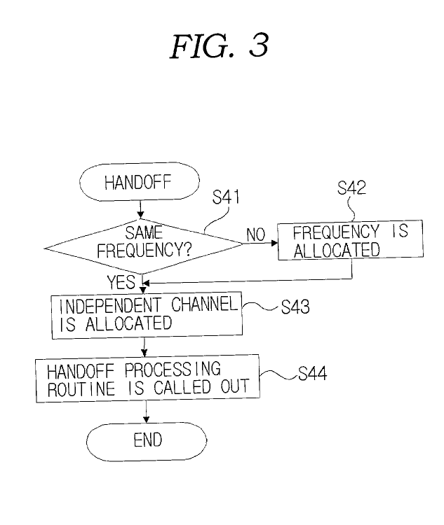

FIG. 3 is a transition view showing the terminal status for carrying out the procedure according to the present invention.

As shown in FIG. 3, in order to carry out the procedure of the present invention, the MC has to be able to carry out the setting of independent multiple PPP links and their controls. The setting of the multiple PPP links should be as follows. That is, in the case where the same frequency handoff RNt uses the frequency of the currently serving *RN, and in the case where it uses a different frequency, the setting should be possible for both of the cases.

Even if the RNt and the *RN use the same frequency, the channels are different from each other, and therefore, a channel allocation procedure has to be carried out. That is, if the channel is different (S41), only the channel allocation is carried out, and then, a handoff processing routine is called out (S44).

In order to carry out the above matter in a sure manner, the MC has to have an independent physical structure, and the applied program has to be able to process the independent controls for the respective links.

In the above, the present invention was described based on the specific preferred embodiment and the attached drawings, but it should be apparent to those ordinarily skilled in the art that various changes and modifications can be added without departing from the spirit and scope of the present invention which will be defined in the appended claims.

According to the present invention as described above, a high speed hard handoff is supported in packet mobile communication network like in the line network, and therefore, a high quality real time service is possible. Accordingly, the real time services such as voice communication and video transmission are possible, and this will render an early introduction of the packet mobile network possible, so that users can efficiently utilize the resources, and that high quality services can be provided at a low cost.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A hard handoff method for making an MC continuously receive internet services by carrying out a hard handoff, comprising the steps of:
carrying out a handoff procedure with a target radio network upon encountering a hard handoff situation in a mobile client (first step);
carrying out a mobile IP registration procedure for the mobile client and for the target packet data service node of the target radio network (second step); and
shifting a traffic channel of the mobile client to a target packet data service node from a current packet data service node (third step).

2. The hard handoff method as claimed in claim 1, wherein the mobile client carries out a setting of independent multiple PPP links and their control functions.

3. The hard handoff method as claimed in claim 2, wherein in setting the multiple PPP links, a channel allocation is carried out in a case of a same frequency.

4. The hard handoff method as claimed in claim 2, wherein in setting the multiple PPP links, a frequency allocation and a channel allocation are carried out in a case of different frequencies.
